(19) United States
(12) Patent Application Publication
(10) Pub. No.: US 2007/0172335 A1
(43) Pub. Date: Jul. 26, 2007

(54) Fastening element for friction-welding to a flat component

(75) Inventor: Eberhard Christ, Tambach-Dietharz (DE)

Correspondence Address: BIRCH STEWART KOLASCH & BIRCH, PO BOX 747, FALLS CHURCH, VA, 22040-0747, US

(73) Assignee: EJOT GmbH & Co. KG, Bad Laasphe (DE)

(21) Appl. No.: 11/638,537

(22) Filed: Dec. 14, 2006

(30) Foreign Application Priority Data
Jan. 26, 2006 (DE) 10 2006 003 806.1

(51) Int. Cl. F16B 23/00

(52) U.S. Cl. 411/408

(57) ABSTRACT

The invention relates to a fastening element with a friction-welding surface for friction-welding to a flat component through rotational force acting on the fastening element and pressing force against the component. The friction-welding surface is bordered by a circular coaxial friction-soldering surface, the friction-welding surface projecting axially in relation to the friction-soldering surface by a length essentially containing only the material required for friction-welding.

The invention relates to a fastening element with a friction-welding surface having a concentric annular ring for friction-welding to a flat component through rotational force acting on the fastening element and pressing force against the component.

Such a fastening element is presented in DE 196 42 331 C2, which relates to a stud with a flange provided at the end of the stud, said flange having a concentric annular ring on its side facing away from the stud. Said annular ring is situated at the radial end of the flange and circularly surrounds a central recess. The friction surface of the annular ring is of convex form, this resulting in an annular linear friction surface on the stud. During the friction-welding process, the known stud allows the required heat for melting of the contact surfaces to be produced through its rotation and pressing against a component.

In addition, a fastening element is known from DE 199 27 369 A1 Figure g, wherein said fastening element is a stud with a flange provided at the end of the stud, said flange having a concentric annular ring on its side facing away from the stud. The friction surface of the annular ring is flat, this resulting in an annular flat friction surface on the stud, said friction surface being able to be attached with considerable cross-section to a flat component through friction-welding.

The object of the invention is to provide the friction-welded connection with protection against corrosion and other chemical influences. The object of the invention is achieved in that the friction-welding surface is bordered by a circular coaxial friction-soldering surface, the friction-welding surface projecting axially in relation to the friction-soldering surface by a length essentially containing only the material required for friction-welding.

Such a design of the fastening element results in the unavoidable succession of friction-welding and friction-soldering in that, initially, the friction-welding surface, which projects in relation to the friction-soldering surface, comes into contact with the flat component, with the result that, here, the friction-welding process can be initiated and executed, wherein the material from the annular ring which is required for friction-welding is absorbed in the friction-welded connection. In the process, the fastening element is brought up close to the component and its friction-soldering surface comes into contact with the component, with the consequence that the friction-soldering surface, which has already been preheated by the friction-welding process, quickly assumes the temperature required for friction-soldering so as to cause the melting of the solder which is on the friction-soldering surface/component. This results in the annular enclosing of the friction-welded connection by the subsequent friction-soldered connection, which tightly encloses the friction-welded connection and protects it against all external influences, especially against corrosion and other chemical influences. The transition from friction-welding to friction-soldering is a continuous one, without there being any interruption in the process of rotation and pressing of the fastening element against the component, this giving rise, therefore, to a functionally self-contained process in which the protection of the friction-welded connection is in effect produced automatically.

For making the friction-soldered connection, it is especially suitable to employ a zinc coating of the component or a coating of the friction-soldering surface with zinc, which has the advantage that a relatively low temperature is required for friction-soldering as compared to friction-welding. The friction-welding of a zinc-coated steel sheet requires a friction-welding temperature of around 1100° C.-1200° C., whereas temperatures of around 300° C.-400° C. are sufficient for friction-soldering when using a zinc coating. Of course, it is also possible to use alternative solders for friction-soldering, such as tin and copper alloys or similar. Given sufficient thickness, for example of the zinc coating of a steel sheet, it may be possible for said zinc coating to provide the required material for the friction-soldering process. Alternatively, however, it is also possible to provide only the friction-soldering surface on the fastening element with a zinc coating or similar in order to execute the friction-soldering process. A particularly secure friction-soldered connection is achieved when both the component and also the friction-soldering surface are coated with solder material.

Advantageously, the friction-welding surface is separated from the friction-soldering surface by an annular groove. Said annular groove is capable of accommodating any abraded material which arises during the friction-welding process, more especially any melt residues and dirt particles, which are then unable to disturb the friction-welding process and, more particularly, the subsequent friction-soldering process.

The friction-welding surface may be flat with a slight slope, the slope extending in either the inward or outward direction. Owing to the slope, there is then formed an edge at the axially highest point of the friction-welding surface, said edge being advantageous for centering the fastening element during rotation and pressing thereof against the component. If the slope extends in the inward direction, i.e. if the distance between the friction-welding surface and the component increases in the inward direction, there will be the tendency for any melt residues and dirt particles to be transported away in the inward direction, whereas, if the slope extends in the opposite direction, i.e. if the axially highest elevation of the friction-welding surface is on the inside, such materials will be transported away in the outward direction. In such a case, the aforementioned waste products can be accommodated in the outward direction by the annular groove.

Advantageously, the friction-welding surface is of convex cross-section. Such a design results, upon contact of the convex friction-welding surface with the component, in a concentric narrow contact line which leads automatically to the centering of the fastening element during the friction-welding process.

The same applies to the design of the friction-soldering surface, which may also be of convex form, this resulting in the friction-soldering process taking place continuously radially inwards and outwards from a central contact line, this giving rise to a uniform soldered connection.

The fastening element may be either in the form of a stud or in the form of a nut, because, in either case, there is the desired protection effect for the friction-welded connection thanks to the presence of the friction-soldered connection.

The friction-welding surface is advantageously provided with at least one radial groove which, during the friction-welding process, forms an opening between the regions inside the friction-welding process and outside the friction-welding process. This connection allows the outward removal of any arising vapours or volatile impurities which would otherwise be enclosed by the interior space formed by the friction-welded connection. Paints and coatings can be scraped off. The radial groove is so narrow that it results in virtually no impairment of the strength of the friction-welded connection. The same considerations also apply if the friction-soldering surface is provided with at least one radial groove.

In order to set the fastening element in rotation with the requisite pressure against the component, the fastening element is advantageously provided with a driver, said driver advantageously being in the form of a hexagon.

Illustrative embodiments of the invention are presented in the drawings, in which:

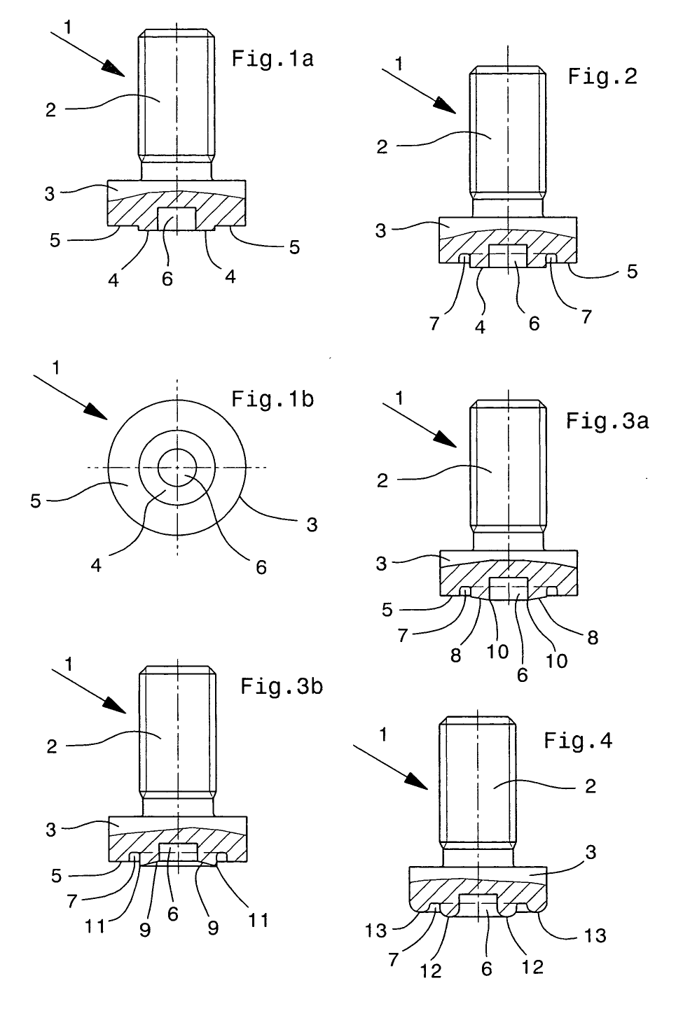

FIG. 1a shows the fastening element in the form of a stud with a friction-welding surface and, directly adjacent thereto, a friction-soldering surface;

FIG. 1b shows an axial top plan view of the fastening element according to FIG. 1a;

FIG. 2 shows a fastening element of similar design to that in FIG. 1 in which an annular groove is provided between friction-welding surface and friction-soldering surface;

FIG. 3a likewise shows a similar fastening element in which the friction-welding surface has a slope, the slope extending in the outward direction;

FIG. 3b shows a variation on the design according to FIG. 3a in which the friction-welding surface slopes in the inward direction;

FIG. 4 shows a design of a fastening element in which both friction-welding surface and also friction-soldering surface are of convex form;

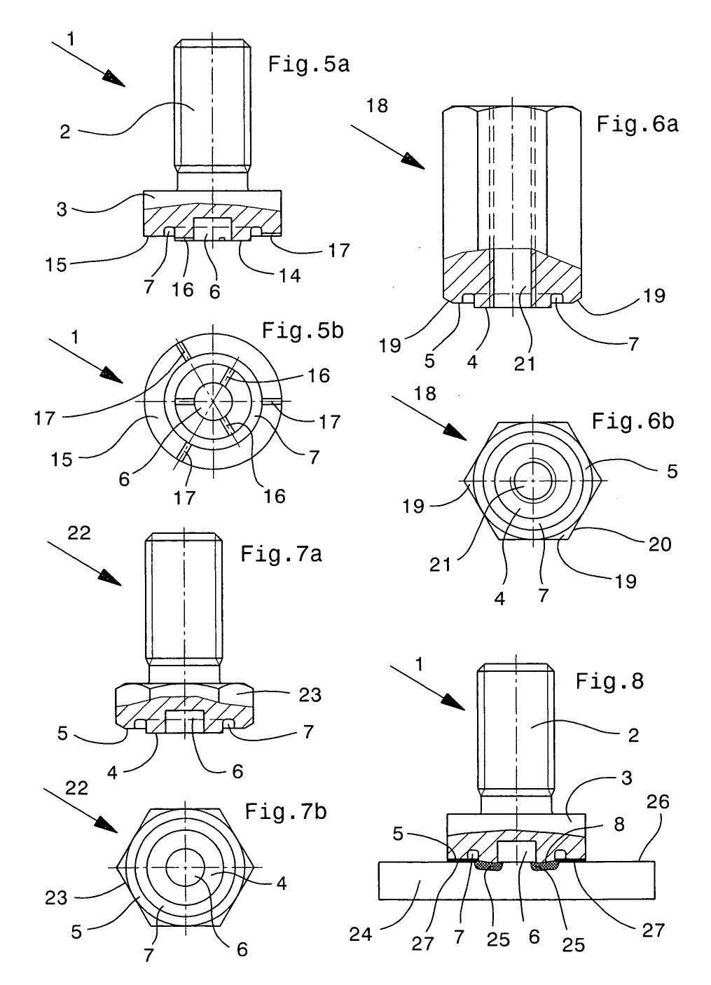

FIG. 5a shows a fastening element which is extensively identical to the one presented in FIG. 2, but with radial grooves both in the friction-welding surface and also in the friction-soldering surface;

FIG. 5b shows an axial view of the fastening element from FIG. 5a, looking onto the friction-welding surface and the friction-soldering surface;

FIGS. 6a and 6b show a fastening element in the form of a nut with friction-welding surface and friction-soldering surface being of a design according to FIG. 2, both in side view and also in top plan view;

FIGS. 7a and 7b show a design of the fastening element similar to that in FIG. 2 in which a driver, in the form of a hexagon, is provided for driving the fastening element;

FIG. 8 shows the fastening element according to FIG. 3a, welded onto a metal part.

FIG. 1 shows the fastening element 1, in the form of a stud, said fastening element 1 being provided on one of its sides with the threaded shank 2 and on its other side with the flange 3, said flange 3 being provided, on the side facing away from the threaded shank 2, with the friction-welding surface 4 and the friction-soldering surface 5. Formed in the centre of the friction-welding surface 4 is the recess 6, which is capable of accommodating any abraded material (melt residues and dirt particles).

FIG. 1b presents the fastening element 1 from FIG. 1a in a top plan view of the friction-welding surface 4 and friction-soldering surface 5.

As is illustrated in FIG. 1a, the friction-welding surface 4 projects slightly in relation to the friction-soldering surface 5 (in practice by approximately 0.2 to 1.0 mm), the consequence of which is, when the fastening element is pressed against a flat component, that, as the fastening element 1 is rotated, initially the friction-welding surface 4 is heated and fuses with the surface of the component, the material from the friction-welding surface 4 being mixed with the material of the component (see FIG. 8). This brings the fastening element 1 with its flange 3 closer to the component until, finally, also the friction-soldering surface 5 comes into contact with the surface of the component, it being the case that, by reason of the pre-heating (caused by the friction-welding process) of component and flange 3, there quickly takes place the melting of a solder situated in the region of the friction-soldering surface 5, with the result that, finally, the friction-soldering surface 5, which completely surrounds the friction-welding surface 4, fuses with the component, thereby shielding the friction-welding surface 4 against the outside. The material of the friction-welding surface 4 is approximately of such a volume as is required for subsequent friction-soldering and joining with the material of the component. This gives rise to a strong connection between fastening element 1 and component (not shown) by means of the friction-welding surface 4, which is securely shielded by the friction-soldering surface 5. With regard to the joining of fastening element 1 and a component, reference is made to FIG. 8.

The fastening element 1 presented in FIG. 2 is extensively identical to the one shown in FIGS. 1a and 1b. In contrast to the fastening element presented in FIGS. 1a and 1b, the fastening element in FIG. 2 is provided with an annular groove 7 between the friction-welding surface 4 and the friction-soldering surface 5. The purpose of said annular groove, which is concentric with the annular friction-welding surface 4 and friction-soldering surface 5, is, during friction-welding, to catch any outwardly transported impurities or material residues, which are thus safely kept away from the friction-soldered connection 5.

FIGS. 3a and 3b present fastening elements 1 which are extensively identical to the one shown in FIG. 2. In FIGS. 3a and 3b, it is merely the case that the friction-welding surface 8 or 9, respectively, is provided with a slight slope, the consequence of which is that, depending on the direction of the slope, there is formed an inner edge 10 of the friction-welding surface in the design according to FIG. 3a or an outer edge 11 of the friction-welding surface 9 in the design according to FIG. 3b. The edge 10 or 11, respectively, ensures that, when the fastening element 1 is placed on a component and rotated, there is an especially intensive centering effect, which extensively prevents any sideways motion during rotation of the fastening element. Furthermore, the slope of the friction-welding surface 8 or 9, respectively, has the effect that the intensive heating during rotation and pressing is produced initially only in the region of the edge 10 or 11, respectively, from where the softening of the respective material then progresses uniformly in the outward direction or in the inward direction, as the case may be, this being of advantage for an effective, continuously uniform friction-welding process. Moreover, the slope ensures that any impurities are either better removed in the outward direction or better removed in the inward direction.

As indicated hereinbefore, both the friction-welding surface and also the friction-soldering surface may advantageously be of convex cross-section. An illustrative embodiment thereof is presented in FIG. 4, in which both the friction-welding surface 12 and also the friction-soldering surface 13 are of convex form. However, it should be noted that it is, of course, also possible for either just the friction-welding surface or just the friction-soldering surface to be of convex form. The convex form of friction-welding surface 12 means that, when the fastening element 1 is placed on a component, there initially results a linear contact with correspondingly intensive concentrated heating, this being of benefit with regard to the speed of execution of the friction-welding process, the melt zone or soldering zone being formed linearly outwards or inwards from the central contact ring in relation to the component, this facilitating the required supply of heat.

FIGS. 5a and 5b present a fastening element 1, similar to the one shown in FIG. 2, in which both the friction-welding surface 14 and also the friction-soldering surface 15 are provided with respective radial grooves 16 and 17, said radial grooves 16 and 17 being especially clearly visible in FIG. 5b (top plan view of the corresponding side of the fastening element 1). The radial grooves 16 and 17 give rise, on the one hand, to an especially strong friction in relation to the corresponding component and, on the other hand, they ensure the safe removal of any melt residues owing to the centrifugal forces they exert. The radial grooves 16 and 17 are of only small depth, as is illustrated by FIG. 5a, and, consequently, have virtually no effect whatsoever on the strength of the subsequent friction-welded and friction-soldered connections. However, they are particularly well suited for the removal of any dirt particles, coatings and melt residues.

As already explained hereinbefore, the fastening element may be either in the form of a stud (FIGS. 1 to 5) or in the form of a nut. For this purpose, reference is made to the nut 18 in FIGS. 6a and 6b. The nut 18 is, at one of its ends, of a design similar to the design presented in FIG. 2. The nut has as its driver the hexagon 20, which may serve, for example, to be engaged by a rotation tool. The nut 18 is provided with the threaded hole 21 and, at its border in the region of the friction-soldering surface 5, with the bevel 19, which prevents any sharp edges in the corresponding region. Moreover, the effect of the bevel 19 is to provide an externally completely rounded and clean friction-soldering surface and therefore soldered connection, as is made clearly apparent by the top plan view presented in FIG. 6b.

FIGS. 7a and 7b present the fastening element 22, in the form of a stud, with a hexagonal flange 23, wherein the side of the flange 23 with the friction-welding surface 4 and friction-soldering surface 5 is identical to the design presented in FIG. 6a. The flange 23 is here in the form of a hexagon, which, similarly to the illustrative embodiment shown in FIG. 6a, allows said flange 23 to be advantageously engaged by a rotation tool for driving the said fastening element.

FIG. 8 presents the fastening element 1 according to FIG. 3a, welded onto a metal part 24 representing the flat component. The flange 3 of the fastening element 1 is pressed against the metal part 24 such that the friction-welding surface 8 becomes welded to the metal part 24 in the friction-welding zone 25, while the friction-soldering surface 5 is joined to the corresponding surface 26 of the metal part 24 by means of the soldering zone 27, where, for example, a zinc coating on the surface 26 and a zinc coating on the friction-soldering surface 5 fuse with each other, i.e. here form the soldered connection between the corresponding portions of metal part 24 and fastening element 1. It becomes apparent from FIG. 8 that the soldering zone 27 encloses the welding zone 25, thereby safely protecting the welding zone 25, which is responsible for securing the fastening element 1 to the metal part 24, against any influences such as corrosion and similar.

1. Fastening element (1, 18, 22) with a friction-welding surface (4, 8, 9, 12, 14) for friction-welding to a flat component (24) through rotational force acting on the fastening element (1, 18, 22) and pressing force against the component (24), characterized in that the friction-welding surface (4, 8, 9, 12, 14) is bordered by a circular coaxial friction-soldering surface (5, 13, 15), the friction-welding surface (4, 8, 9, 12, 14) projecting axially in relation to the friction-soldering surface (5, 13, 15) by a length essentially containing only the material required for friction-welding.

2. Fastening element according to claim 1, characterized in that the friction-welding surface (4, 8, 9, 12, 14) is separated from the friction-soldering surface (5, 13, 15) by an annular groove (7).

3. Fastening element according to claim 1, characterized in that the friction-welding surface (9, 8) has a slope in the radial direction.

4. Fastening element according to claim 1, characterized in that the friction-welding surface is of convex cross-section (12).

5. Fastening element according to claim 1, characterized in that the friction-soldering surface (13) is of convex form.

6. Fastening element according to claim 1, characterized in that the fastening element is in the form of a stud (1).

7. Fastening element according to claim 1, characterized in that the fastening element is in the form of a nut (18).

8. Fastening element according to claim 1, characterized in that the friction-welding surface (14) has at least one radial groove (16).

9. Fastening element according to claim 1, characterized in that the friction-soldering surface (15) has at least one radial groove (17).

10. Fastening element according to claim 1, characterized by a driver (20, 23) for application of the rotational force and pressing force.

11. Fastening element according to claim 10, characterized in that the driver (20, 23) is in the form of a hexagon.
